(19) United States
(12) Patent Application Publication
(10) Pub. No.: US 2009/0291181 A1
(43) Pub. Date: Nov. 26, 2009

(54) APPARATUS AND A METHOD FOR PRODUCING BOWL-SHAPED FOOD PRODUCTS

(76) Inventor: Achim Krischer, Wipperfurth (DE)

Correspondence Address: AT & T Legal Department - WS;Attn: Patent Docketing, Room 2A-207, One AT & T Way, Bedminster, NJ, 07921, US

(21) Appl. No.: 12/312,839

(22) PCT Filed: Sep. 27, 2007
(86) PCT No.: PCT/CH2007/000478

§ 371 Date: May 27, 2009

(30) Foreign Application Priority Data
Nov. 27, 2006 (DE) 10 2006 056 262.3

(51) Int. Cl. A23G 3/02; A23G 1/21

(52) U.S. Cl. 426/512; 425/116

(57) ABSTRACT

A method and apparatus for producing bowl-shaped food products from a fat-containing compound. The apparatus includes a mold block having hollow molds formed by depressions so as to define an inside surface of the food product and a support frame having a die block formed by die elements, each having a bulge for determining an outside surface of the food product. The interchangeable support frame is movable with respect to the mold block between an operating position and a non-operating position, such that in the operating position the die elements are disposed within a respective hollow mold. The die block and the mold block can be independently cooled during operation. The support frames and the die blocks can be quickly changed to form food products having different shapes.

The invention relates to an apparatus according to the preamble of claim 1 and to a method according to the preamble of claim 22 or 23 for producing bowl-shaped food products from a fat compound, especially from a cocoa-containing or chocolate-like fat compound.

Such known apparatuses and methods show a lack of flexibility in the production line when changing over the production to another food product. Moreover, such changes in product are not only time-consuming, but also pose a challenge to the expert knowledge of the operating staff.

The invention is based on the object of eliminating the disadvantages of the aforementioned known apparatuses and methods.

This object is achieved in accordance with the apparatus according to claim 1.

In accordance with the invention, the die-block support frame is arranged as a die-block interchangeable frame, on which several die blocks are arranged in a displaceable manner relative to the interchangeable frame and each of the die blocks is displaceable with respect to the interchangeable frame between an operating position in which it cooperates in the shaping of the food products during the lowering of the die-block interchangeable frame against the mold block and a non-operating position in which it does not cooperate during the lowering of the die-block interchangeable frame against the mold block.

The object is achieved in accordance with the method according to claims 22 and/or 23.

This is achieved in accordance with the invention by choosing one of the several die blocks and by using the selected die block for at least one step cycle, having the step a), the step b) and the step c), and/or by choosing one of the several die-block interchangeable frames, and by using the selected die-block interchangeable frame for at least one step cycle having the step a), the step b) and the step c).

Further advantageous embodiments of the invention are defined in the dependent claims.

Further advantages, features and possibilities for application are given from the following description, not to be understood as being limiting in any way, by reference to the drawings, wherein:

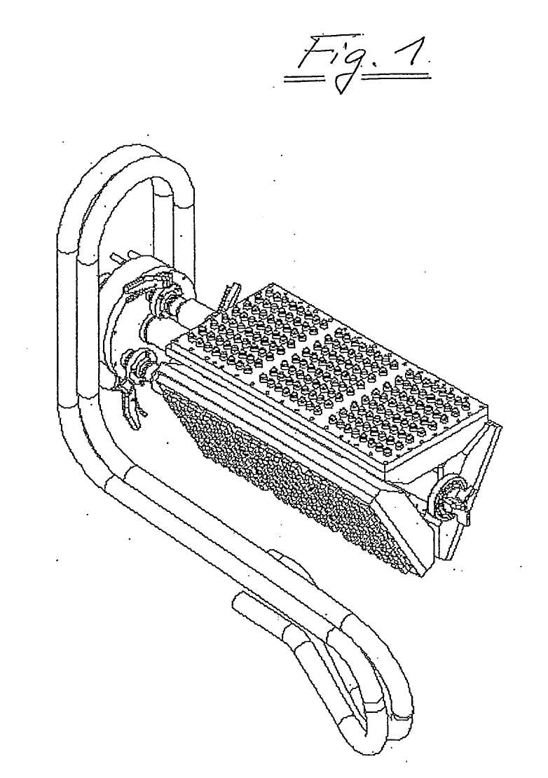

FIG. 1 shows a first module of the apparatus in accordance with a preferred embodiment of the invention;

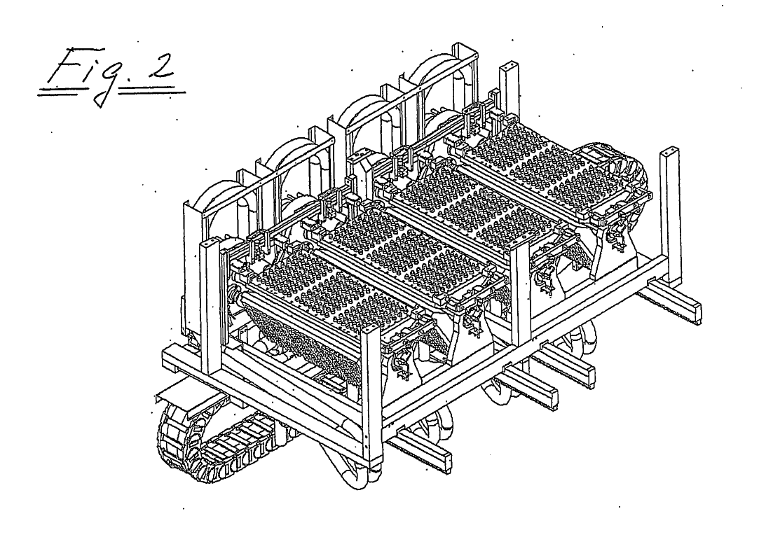

FIG. 2 shows a second module of the apparatus in accordance with the invention comprising several of the first modules of FIG. 1, according to a preferred embodiment of the invention.

The invention relates to a method and an apparatus for producing chocolate articles, especially for casings for hollow chocolate bodies, in which the liquid chocolate mass is metered in a predetermined amount to an alveole arranged in a mold, and thereafter a die element is immersed into the chocolate and is removed again after a predetermined dwell time has expired. For this purpose, the die element may alternatively perform a vertical movement, or the mold can be lifted underneath the die element by means of suitable means. To this end, both fixed dies (milled die plate) and flexible, resilient dies may be used.

In order to optimize the method and/or the apparatus with respect to flexibility of product changes within a chocolate production facility, it is provided in accordance with the invention to mount one, two or several die blocks of various characteristics onto an interchangeable frame, so that a product change is enabled even without requiring any tools in a very short amount of time.

### EXAMPLE

A star-shaped arrangement with three die blocks (see FIG. 1) on the interchangeable frame allows changing a product between three different products by manual, pneumatic or motive pivoting (here: ±120°) via a horizontal axis orthogonally to the direction of transport without any major reconfiguration time.

These interchangeable frames can be arranged alternatively in a fixed main frame for low production facility speeds or several times behind one another in a movable main frame (see FIG. 2) in order to enable shorter machine cycle times. When using several interchangeable frames at higher speeds, they need to be entrained with the motion of mold transport in order to enable sufficient die time and to enable sufficient dissipation of heat from the chocolate. As a result of the entrainment of the main frame, die times can be reached which last longer than a cycle time. In the case of two interchangeable frames in a main frame, the main frame can use one machine cycle for stamping and co-move synchronously with the die transport, leaving one cycle in order to return to the initial position. An interchangeable frame system with four interchangeable frames can be used for even higher production facility speeds. In this case, the main frame co-moves for two cycles and two cycles remain for the return to the initial position. Arrangements with an uneven number of interchangeable frames are only useful for non-cycled, continuously running mold transports because in this case it is not necessary to consider the standstill positions of the molds for the start and end of stamping.

The arrangement of several interchangeable frames behind one another can also enable the simultaneous production of different articles without interruption of the production in the case of suitable periphery and slow cycle rates. The rotation of the interchangeable frame from mold to mold is also an option.

The invention is characterized in that as a result of the described configuration a change of the die blocks is made by a suitable apparatus and therefore far less expert knowledge of the operating staff is required than in current systems. The more important second point is the saving of time in changing products. The resulting main benefit is the substantial improvement in the flexibility of the production line with respect to the changing of products.

1-24. (canceled)

25. An apparatus for producing bowl-shaped food products from a fat-containing compound, the apparatus comprising:
a mold block having a plurality of hollow molds formed by depressions, each hollow mold having a surface for determining an outside surface of a bowl-shaped food product;
a die block having a plurality of die elements, each die element having a bulge having a surface for determining an inside surface of the bowl-shaped food product; and
an interchangeable support frame configured to hold a plurality of die blocks, the support frame being movable with respect to the mold block between an operating position and a non-operating position, such that in the operating position each of the plurality of die elements of a respective one of the plurality of die blocks are disposed within a respective one of the plurality of hollow molds, and in the non-operating position each of the plurality of die elements of the respective one of the plurality of die blocks are disposed outside of the plurality of hollow molds such that the plurality of hollow molds can be filled with the fat-containing compound in a free-flowing tempered state.

26. The apparatus of claim 25, wherein each of the plurality of die blocks are displaceable with respect to the interchangeable frame between the operating position and the non-operating position.

27. The apparatus of claim 25, wherein the support frame is rotatable so as to move each of the plurality of die blocks between the operating position and the non-operating position.

28. The apparatus of claim 27, wherein the support frame is rotatable about a rotational axis such that the plurality of die elements of each die block protrude outwardly from a rotational axis in an angular offset along the circumferential direction.

29. The apparatus of claim 28, wherein:
a surface of the mold block defines a first plane, an upper boundary edge of each hollow mold being a first closed curve line disposed in the first plane;
a surface of each die blocks defines a second plane, a bottom base line of each bulge being a second closed curve line disposed in the second plane; and
the second plane of each of the die blocks is aligned tangentially to an imaginary cylindrical surface enclosing the rotational axis in a concentric manner.

30. The apparatus of claim 29, wherein the plurality of die blocks are disposed about the rotational axis so as to form a prism having a polygonal base.

31. The apparatus of claim 30, wherein the plurality of die blocks are disposed about the rotational axis so as to form a regular prism having a regular polygonal base.

32. The apparatus of claim 31, wherein the prism is a triangular prism having a triangular base.

33. The apparatus of claim 31, wherein the prism is a square having a square base.

34. The apparatus of claim 25, wherein the plurality of die blocks are manually displaceable relative to the support frame.

35. The apparatus of claim 25, wherein the plurality of die blocks are pneumatically displaceable relative to the support frame.

36. The apparatus of claim 25, wherein the plurality of die blocks are hydraulically displaceable relative to the support frame.

37. The apparatus of claim 25, wherein the plurality of die blocks are displaceable relative to the interchangeable frame by an electromotor.

38. The apparatus of claim 25, wherein each of the plurality of die blocks and the support frame are in a latched position in the operating position and in the non-operating position.

39. The apparatus of claim 25, wherein at least one of the plurality of die blocks and the plurality of die elements are adapted to be cooled.

40. The apparatus of claim 39, wherein at least one of the plurality of die blocks and the plurality of die elements are cooled using cooled air flowing around the at least one of the plurality of die blocks and the plurality of die elements.

41. The apparatus of claim 39, wherein at least one of the plurality of die blocks and the plurality of die elements are cooled by distributing a cooled fluid through the at least one of the plurality of die blocks and the plurality of die elements.

42. The apparatus of claim 25, wherein the plurality of die blocks include two or more die element designs.

43. The apparatus of claim 42, wherein at least two die blocks are cooled according to a different respective cooling level.

44. The apparatus of claim 42, wherein the plurality of die blocks differ from each other with respect to at least one of a number of the respective plurality of die elements and a shape of the respective plurality of die elements.

45. The apparatus of claim 25, further comprising a plurality of interchangeable support frames.

46. A method for producing a bowl-shaped food product from a fat compound using an apparatus according to claim 25, comprising the steps of:
a. selecting one of a plurality of die blocks for use with the apparatus;
b. using the selected die block for at least one cycle of the following steps c, d, and e;
c. filling the plurality of hollow molds with a predetermined amount of the fat compound in the free-flowing tempered state, a temperature of the plurality hollow molds being lower than a temperature of the fat compound;
d. submersing the plurality of die elements into the fat compound in the plurality of hollow molds, such that that the fat compound is distributed in an intermediate space between each of the plurality of hollow molds and a respective one of the plurality of die elements, a temperature of the plurality of die elements being lower than the temperature of the tempered fat compound; and
e. holding the plurality of die elements in a submerged position over a period of time until the fat compound solidifies in the intermediate space.

47. A method for producing a bowl-shaped food product from a fat compound, using an apparatus according to claim 45, comprising the steps of:
a. selecting one of a plurality of interchangeable support frames;
b. using the selected interchangeable support frame for at least one cycle of the following steps c, d, and e;
c. filling the plurality of hollow molds with a predetermined amount of the fat compound in the free-flowing tempered state, a temperature of the plurality hollow molds being lower than a temperature of the fat compound;
d. submersing the plurality of die elements into the fat compound in the plurality of hollow molds, such that that the fat compound is distributed in an intermediate space between each of the plurality of hollow molds and a respective one of the plurality of die elements, a temperature of the plurality of die elements being lower than the temperature of the tempered fat compound; and
e. holding the plurality of die elements in a submerged position over a period of time until the fat compound solidifies in the intermediate space.
